(19) United States
(12) Patent Application Publication
(10) Pub. No.: US 2009/0199700 A1
(43) Pub. Date: Aug. 13, 2009

(54) Knob for Adjusting a Rotatable Control on an Instrument Pedal

(76) Inventor: Samuel Goldstein, Merion, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/028,212

(22) Filed: Feb. 8, 2008

(51) Int. Cl. G10H 1/32

(52) U.S. Cl. 84/746

(57) ABSTRACT

A knob for adjusting a rotatable control on a foot operated musical instrument effects pedal is disclosed. The knob has a shaft having a first end, a second end, and an outer perimeter bounding a first cross-sectional area, the first end being securable to the rotatable control. The knob also has a wheel located at the second end of the shaft, the wheel having an outer perimeter bounding a second cross-sectional area which is greater than the first cross-sectional area, a bottom surface rigidly attached to the second end of the shaft, and a top surface located opposite the bottom surface, wherein at least a portion of the top surface has a frictional surface adapted to receive a user's foot for rotating the knob and thereby adjusting the rotatable control.

### BACKGROUND OF THE INVENTION

1. Field of Invention

This invention relates generally to instrument pedals, e.g., guitar effects pedals, and more particularly to knobs for adjusting rotatable controls, e.g., rotary potentiometers or switches, on such pedals.

2. Description of Related Art

Instrument pedals (e.g., guitar effects pedals) are well known in the art, and have become widely popular tools for enhancing and manipulating audio signals produced by electronic musical instruments. Popular audio effects produced by such pedals include various types of distortion (e.g., fuzz, heavy metal), chorus, flange, phaser, delay, reverb, as well as simple volume adjustment, to name a few.

Instrument pedals generally comprise a metal housing containing various electronic components, a foot operated on-off switch, and a plurality of rotatable knobs for controlling, for example, rotary potentiometers or switches which provide independent adjustment of the various operating parameters and functions of the pedals. On a distortion pedal, for example, a user may adjust a rotatable knob clockwise to generate a distortion effect that makes it sound as if the instrument is being played loud enough to overwhelm the amplifier. The user can alternatively rotate the same knob counterclockwise to make it sound as if the instrument is being played quietly and clearly.

Instrument pedals have done much to enhance the performance capabilities of musicians. One advantage of having a miniature effects processor in the form of a pedal is that it allows a musician to actuate the pedal, i.e., turn it on and off, with his or her foot. However, the typical “foot” pedal does not enable a musician to adjust the pedal's operating parameters, e.g., effects levels, with his or her foot.

Although they are generally resigned to living with this shortcoming, musicians are often frustrated that they cannot use their feet to easily adjust the levels of effects generated by typical instrument pedals, and instead must adjust levels using their hands, which would optimally be left free to play their instruments. Suppose, for example, a guitar player during a live performance is in the midst of a dramatic solo with an effect pedal generating a moderate level of distortion. He gets to a point where he would like to add even more distortion. With a typical pedal, he would have to stop playing momentarily in order bend down and adjust the level of distortion with his hand. This rather anticlimactic outcome could be avoided if the guitar player had the ability to easily rotate the knob used to adjust the level of distortion on his pedal with his foot, instead of his hand.

Several attempts have been made to address this problem during the four or so decades since instrument pedals have been on the market. They are all, however, severely deficient in various respects.

For example, one attempt to address the problem is embodied in the pedal described in U.S. Pat. No. 5,981,862 to Geier (Geier). Geier describes a pedal having a built-in control disk which is rotatable about a horizontal axis, and is suitable for manual rotation by a foot. The disk enables foot operated adjustment of levels of an effect generated by the pedal.

Although the pedal described in Geier enables hands-free adjustment of effects levels, one of its drawbacks is that the control disk is an inseparable component of the pedal. Consequently, it does not enable hands-free operation of a previously purchased pedal. Therefore, a user would need to purchase the entire pedal described in Geier (or a plurality of such pedals, if a number of different effects are desired) at a considerable cost, to enjoy the benefits of its hands-free operation. Geier therefore does not address the needs of millions of current owners of standard instrument pedals, who would like to have full hands-free capabilities with their existing pedals, without having to purchase a new pedal such as that described in Geier. Moreover, every type and brand of effect pedal produces its own distinct sound, and most musicians prefer to choose among all the effect pedals, instead of just those made according to Geier. Furthermore, even on a Geier pedal, a musician would need to let go of his instrument and bend down to adjust any controls other than the one that can be adjusted by the control disk.

Other attempts to address the problem include expression pedals, which are available in both electronically actuated, and mechanically actuated types. Both types resemble guitar “wah-wah” pedals (see, for example, the “wah-wah” pedal described in U.S. Pat. No. 3,530,224 to Plunkett). The standard expression pedal generally comprises a relatively large rectangular base (e.g., 7 inches by 2.5 inches), with a pivoting pedal mounted on top, having a surface area that is approximately equal to that of the sole of an adult human foot.

An electronically actuated expression pedal has an output adaptable to receive a standard ¼ inch guitar cable. Once a cable is inserted into the output, the other end of the cable can be inserted into a dedicated expression input of a compatible instrument pedal, thereby enabling electrical communication between the pedals. If a user would like to adjust the level of an effect generated by the instrument pedal, he or she may actuate the expression pedal. This action causes an electronic signal to be sent to the instrument pedal, which, in turn, adjusts the effect level generated by the instrument pedal.

A mechanically actuated expression pedal includes a cable extending therefrom, having an end that fits over a rotatable control of an instrument pedal. By actuating the expression pedal, a user causes the cable to mechanically rotate the instrument pedal's rotatable control.

Although expression pedals enable hands-free adjustment of instrument pedals, they have several drawbacks. First, they are rather large—approximately as large, if not larger, than standard instrument pedals. Expression pedals therefore occupy additional floor and luggage space, which is often limited, especially when a musician has a setup which includes a plurality of instrument pedals.

Second, they are expensive. Expression pedals retail, on average, for between $50 to $100. This cost rivals that of many instrument pedals. Thus, if a musician wishes to have a companion expression pedal for each of his instrument pedals, he can expect to spend approximately double the amount he spent on his instrument pedals alone. Consequently, cost conscious musicians are often reconciled to using their hands for adjusting levels on instrument pedals.

A third drawback, particular to electronically actuated expression pedals, is that such pedals are often proprietary, i.e., they are generally compatible only with specific brands of instrument pedals. Moreover, they necessitate the additional expense of another guitar cable for establishing an electronic connection between the expression pedal and the instrument pedal.

A fourth drawback, particular to mechanically actuated expression pedals, is that they are sometimes unable to rotate knobs on instrument pedals having substantial rotational resistance, e.g., rotational switches.

Recently filed U.S. Pat. App. 2007/0176729 to Ebrey (Ebrey) further illustrates the enduring failure of skilled artisans to adequately address the need for hands-free parameter adjustment capabilities for instrument pedals. Ebrey describes a hand-actuated rotatable knob connected to a long drive shaft having a bottom end that connects to a rotatable control of an instrument pedal. The rotatable knob of Ebrey can be mounted a few feet off the ground, e.g., on a microphone stand, in order to be within reach of a musician in a standing position. The musician can rotate the knob of Ebrey in order to adjust the rotatable control of the instrument pedal to which the drive shaft is attached. Although the device described in Ebrey obviates the need for a musician to have to bend down to adjust a knob on an instrument pedal, it fails to address the problem because it does not enable hands-free adjustment of the knob.

In light of the shortcomings of attempts to satisfy the need for hands-free instrument pedal knob adjustment, musicians sometimes resort to purchasing several of the same model of effect pedal, in order to use more than one of the various sounds that the pedal can produce. Of course, cost conscious musicians avoid this way of addressing the problem, and even musicians who do purchase several models of the same pedal can choose only from the settings that they set at the beginning of a performance.

As technologically advanced as instrument pedals have become over the last forty years, there is no product on the market that adequately satisfies the long-felt need for an inexpensive, hands-free instrument pedal parameter adjuster, which is compatible with virtually all standard instrument pedals and which does not occupy any floor space.

### BRIEF SUMMARY OF THE INVENTION

Accordingly, a knob for adjusting a rotatable control on a foot operated musical instrument effects pedal is provided. The knob has a shaft having a first end, a second end, and an outer perimeter bounding a first cross-sectional area. The first end is securable to the rotatable control. The knob also has a wheel located at the second end of the shaft. The wheel has an outer perimeter bounding a second cross-sectional area which is greater than the first cross-sectional area, a bottom surface rigidly attached to the second end of the shaft, and a top surface located opposite the bottom surface. At least a portion of the top surface has a frictional surface adapted to receive a user's foot for rotating the knob and thereby adjusting the rotatable control.

### BRIEF DESCRIPTION OF SEVERAL VIEWS OF THE DRAWINGS

The invention will be described in conjunction with the following drawings in which like reference numerals designate like elements and wherein:

FIG. 1 is an isometric view of a typical prior art foot operated musical instrument effects pedal.

FIG. 2 is an isometric view of a knob according to the present invention.

FIG. 3 is an isometric exploded view of the knob of FIG. 2.

FIGS. 4a-4c illustrate the steps involved in securing the knob of FIG. 2 onto a rotatable control on the pedal of FIG. 1. FIG. 4a shows a user removing a preinstalled rotatable control knob from the pedal of FIG. 1. FIG. 4b shows the placing of the knob of FIG. 2 onto a rotatable control post of the pedal of FIG. 1. FIG. 4c shows the securing of the knob of FIG. 2 onto the control post of the pedal with a standard hex wrench.

FIG. 5 shows a user's foot operating the knob-pedal combination of FIG. 4c.

FIG. 6 is an overhead view of the knob-pedal combination of FIGS. 4c and 5.

FIGS. 7a-d show isometric views of examples of the various shapes that a knob according to the present invention may take.

### DETAILED DESCRIPTION OF THE INVENTION

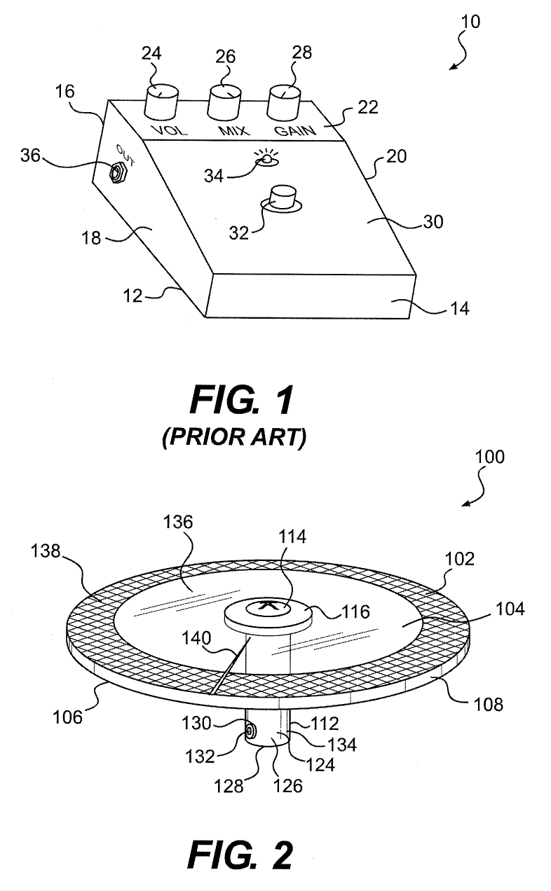

Referring now to the various figures wherein like reference characters refer to like parts, there is shown in FIG. 1 an isometric view of a typical prior art foot operated musical instrument effects pedal 10. The pedal 10 in this instance is a guitar distortion pedal, although the present invention contemplates any foot operated musical instrument effects pedal having rotatable controls.

The pedal 10 comprises a metal housing having a substantially rectangular base 12, from which extend front 14 and rear 16 vertical walls, as well as left 18 and right 20 sidewalls. A horizontal control platform 22 having three rotatable knobs 24, 26 and 28 for controlling the levels of various effects, extends forward from the rear wall 16. The rotatable knobs 24, 26 and 28 include a volume knob 24 for adjusting instrument volume, a mix knob 26 for adjusting the proportion of effect-signal to non-effect-signal, and a gain knob 28 for adjusting the level of instrument gain or distortion.

Sloping downward from the horizontal control platform 22 until intersecting the front wall 14 is the top surface 30 of the pedal 10. A foot operated pedal actuator 32, which a user's foot may depress in order to turn the pedal 10 on and off, is located in the center of the top surface 30 of the pedal 10. A light 34, which is illuminated when the pedal 10 is on, is located slightly above the pedal actuator 32 on the top surface 30 of the pedal 10.

The left sidewall 18 includes an output 36 adapted to receive a standard ¼ inch guitar cable (not shown) for electrical communication between the pedal 10 and another pedal (not shown), a recording device (not shown), or an amplifier (not shown).

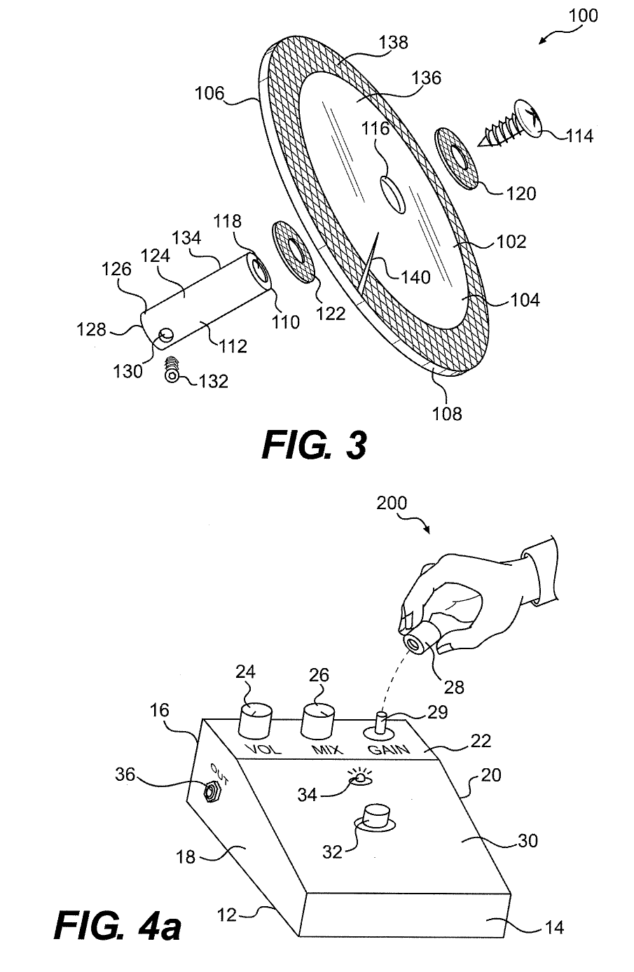

Referring now to FIGS. 2 and 3, there is shown a knob 100 according to the present invention. FIG. 2 shows the knob 100 fully assembled, while FIG. 3 shows an exploded view of the knob 100 of FIG. 2. The knob 100 is adapted to replace, or be secured onto, a preinstalled rotatable control knob, as explained infra.

The knob 100 comprises a circular wheel 102 having top 104 and bottom 106 surfaces, and an outer perimeter 108 bounding a first cross-sectional area. The wheel 102 is secured to the top end 110 of a partially hollow cylindrical shaft 112 by a screw 114 which is inserted through a hole 116 in the center of the wheel 102, and which is received by a vertical threaded opening 118 in the top end 110 of the shaft 112. An upper washer 120 sits between the head of the screw 114 and the top surface 104 of the wheel 102. A bottom washer 122 sits between the bottom surface 106 of the wheel 102 and the top end 110 of the shaft 112.

The shaft 112 further comprises an outer wall 124, a bottom end 126 having a vertical opening 128, and a threaded opening 130 through the outer wall 124 which is adapted to receive a set screw 132. The shaft 112 has an outer perimeter 134 bounding a second cross-sectional area which is smaller than the first cross-sectional area of the wheel 102. Preferably, the first cross-sectional area is at least three times greater than the second cross sectional area.

The wheel 102 and shaft 112 can be constructed out of any rigid, durable material, such as plastic, metal or hard rubber. The wheel 102 as depicted in FIGS. 2 and 3 is made out of a hard, transparent plastic. As such, a user would be able to see through at least a portion 136 of the wheel 102.

Positioned on the top surface 104 of the wheel 102, adjacent to the outer perimeter 108 of the wheel 102, is optionally a frictional surface 138 adapted to receive a user's foot for rotating the knob 100, in order to adjust a rotatable control on a pedal. The frictional surface 138 can be made out of any material which permits a user to easily rotate the knob 100 with his or her foot. For example, the frictional surface 138 may comprise sandpaper, rubber or adhesive that is integral to the wheel 102. Alternatively, the frictional surface 138 may include no materials in addition to that of the top surface 104 of the wheel 102, but may simply comprise an abrasive surface, or friction-generating pattern machined or molded onto the top surface 104 of the wheel 102.

The top surface 104 of the wheel 102 further includes a thin dark line 140 extending from the outer perimeter 108 of the wheel 102, towards the center of the wheel 102. The line 140 may serve as a visual indicator to indicate to the user the degree of rotation of a rotatable control on a pedal, as explained infra.

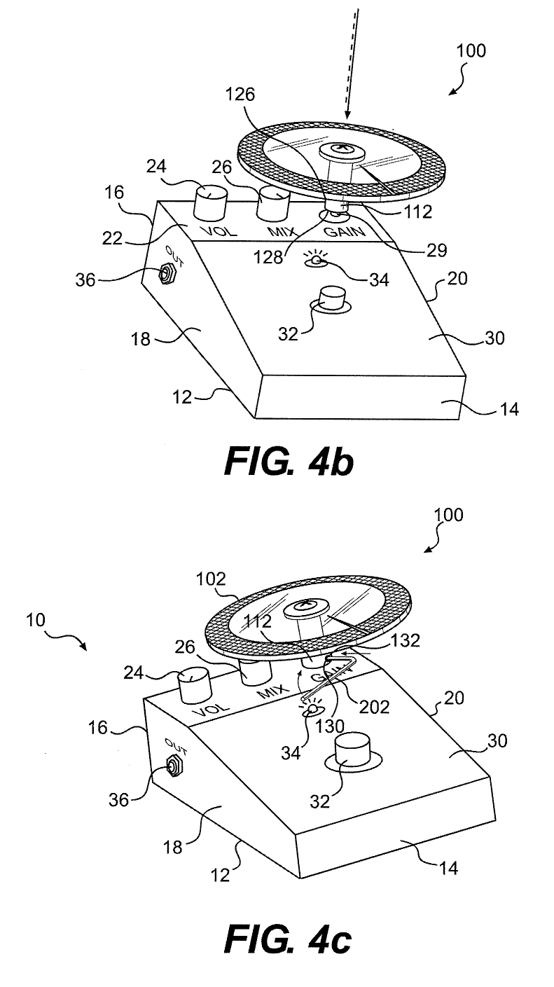

Referring now to FIGS. 4a-c, there is shown a series of sequential illustrations demonstrating the steps a user may take to secure the knob 100 of FIGS. 2 and 3 to the pedal 10 of FIG. 1. FIG. 4a shows a user's hand 200 removing the preinstalled gain knob 28 from an underlying rotatable control post 29. The preinstalled gain knob 28 only enables a user to rotate the knob 28 by hand—not by foot—in order to adjust the level of gain generated buy the pedal 10.

Once the preinstalled gain knob 28 is removed and the control post 29 is exposed, the user places the inventive knob 100 of FIGS. 2 and 3 over the control post 29, such that the vertical opening 128 at the bottom end 126 of the shaft 112 receives the post 29, as shown in FIG. 4b.

Once the shaft 112 has been firmly placed over the post 29, as shown in FIG. 4c, the user may secure the shaft 112 onto the post 29 by tightening, e.g., with a standard hex wrench 202, the set screw 132 into the threaded opening 130 until the set screw 132 tightly presses against the control post 29 housed within the shaft 112. Once the shaft 112 is securely fastened to the control post 29, the knob 100 is ready for use.

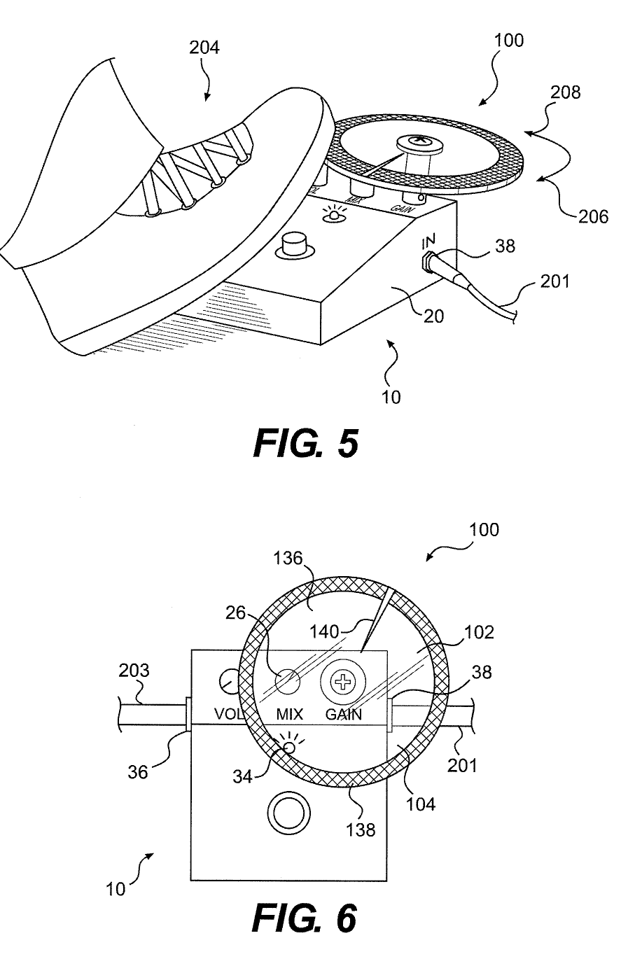

As shown in FIG. 5, the right sidewall 20 of the pedal 10 includes an input 38 adapted to receive a standard ¼ inch guitar cable 201 to enable electrical communication between an electronic instrument (not shown), or another pedal (not shown), and the pedal 10. FIG. 5 illustrates a user's foot 204 rotating the knob 100 in order to adjust the level of gain generated by the pedal 10. In order to increase the gain level, the user's foot 204 would rotate the knob 100 clockwise 206. In order to decrease the gain level, the user's foot 204 would rotate the knob 100 counterclockwise 208. The user is thus able to easily adjust the knob 100, without using his or her hands. The same cannot be said regarding the preinstalled control knob 28 of FIG. 4a. The knob 100 of the present invention therefore provides a distinct advantage over standard instrument pedal knobs.

Referring now to FIG. 6, there is shown an overhead view of the knob 100 and pedal 10 combination of FIG. 5. From the perspective shown in FIG. 6, it can be seen that the transparent portion 136 of the wheel 102 permits a user to view parts of the pedal 10 located directly beneath the wheel 102, e.g., the mix knob 26 and light 34. In this way, the relatively large cross-sectional area of the wheel 102 will not obscure from view portions of the pedal 10 that the user may wish to see. FIG. 6 further shows how the line 140 on the top surface 104 of the wheel 102 can be used to indicate to the user the degree of rotation of the knob 100, and hence, the level of distortion generated by the pedal 10.

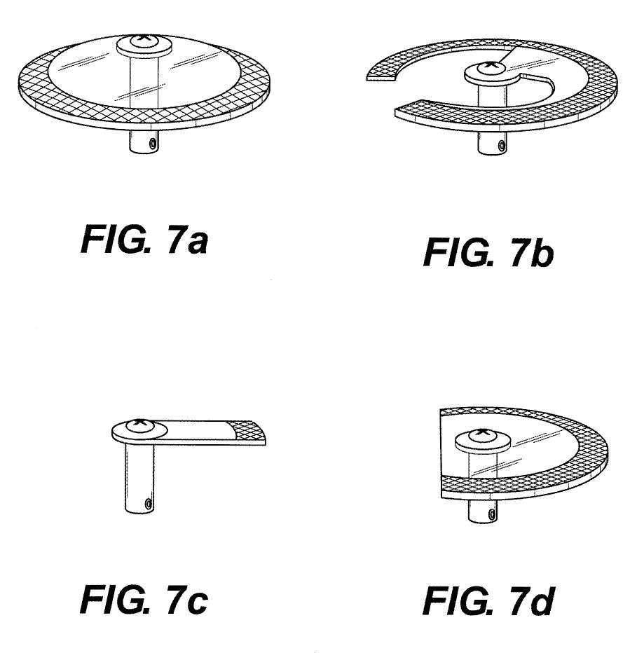

Importantly, the wheel of the present invention need not be circular, and in fact, is not limited to any particular shape or size. FIGS. 7a-d illustrate examples of shapes and styles suitable for wheels according to the present invention, including rounded-top (FIG. 7a), circular cut-out (FIG. 7b), uni-arm (FIG. 7c) and incomplete circular (FIG. 7d).

Referring again to FIGS. 4c, 5 and 6, in another aspect of the invention, the height of the shaft 112 exceeds that of the adjacent mix knob 26, and the wheel 102 of the knob 100 extends over at least a portion of the knob 26. In this position, the knob 100 of the present invention does not interfere with the rotational capability of the other knob 26, and vice versa.

In another aspect of the invention, the knob 100 as shown in FIG. 5 may come preinstalled onto the pedal 10, thus obviating the need of a user, as illustrated by FIGS. 4a-c, to remove the preinstalled knob 28 in order to secure the inventive knob 100 to the exposed control post 29.

In yet another aspect of the invention (not shown), the shaft of the knob of the present invention may be adapted to be secured directly onto a preinstalled knob on a pedal, as opposed to being secured onto a control post. In this way, a user would not need to remove the preinstalled knob 28 in order to secure the inventive knob 100 to the exposed control post 29, as illustrated by FIGS. 4a-c. Rather, the user could omit the step illustrated in FIG. 4a, and secure the shaft directly onto the preinstalled knob.

In still another aspect of the invention (not shown), a plurality of inventive knobs are provided in a kit. The kit comprises at least a first knob and a second knob which both largely resemble the knob of FIGS. 2 and 3. The primary difference between the first and second knobs is that the height of the shaft of the first knob exceeds that of the second knob, such that when standing directly adjacent to one another on a level surface, there is clearance between the bottom surface of the wheel of the first knob, and the top surface of the wheel of the second knob. In this way, if both knobs are secured to adjacent rotatable controls on the same pedal, the first knob will not interfere with the rotational capability of the second knob, and vice versa.

While the invention has been described in detail and with reference to specific examples thereof, it will be apparent to one skilled in the art that various changes and modifications can be made therein without departing from the spirit and scope thereof.

What is claimed is:

1. A foot operated musical instrument effects pedal comprising a knob for adjusting a rotatable control, the knob comprising:
a. a shaft having a first end, a second end, and an outer perimeter bounding a first cross-sectional area, the first end being securable to the rotatable control;
b. a wheel located at the second end of the shaft, the wheel having an outer perimeter bounding a second cross-sectional area which is greater than the first cross-sectional area, a bottom surface rigidly attached to the second end of the shaft, and a top surface located opposite the bottom surface, wherein at least a portion of the top surface has a frictional surface adapted to receive a user's foot for rotating the knob and thereby adjusting the rotatable control.

2. The pedal of claim 1 wherein the second cross-sectional area is at least three times greater than the first cross-sectional area.

3. The pedal of claim 1 wherein at least a portion of the wheel is transparent.

4. The pedal of claim 1 wherein the first end of the shaft is removably securable to the rotatable control.

5. The pedal of claim 1 wherein the frictional surface is selected from the group consisting of sandpaper, rubber and adhesive.

6. A knob for adjusting a rotatable control on a foot operated musical instrument effects pedal, the knob comprising:
a. a shaft having a first end, a second end, and an outer perimeter bounding a first cross-sectional area, the first end being securable to the rotatable control;
b. a wheel located at the second end of the shaft, the wheel having an outer perimeter bounding a second cross-sectional area which is greater than the first cross-sectional area, a bottom surface rigidly attached to the second end of the shaft, and a top surface located opposite the bottom surface, wherein at least a portion of the top surface has a frictional surface adapted to receive a user's foot for rotating the knob and thereby adjusting the rotatable control.

7. The knob of claim 6 wherein the second cross-sectional area is at least three times greater than the first cross-sectional area.

8. The knob of claim 6 wherein at least a portion of the wheel is transparent.

9. The knob of claim 6 wherein the first end of the shaft is removably securable to the rotatable control.

10. The knob of claim 6 wherein the shaft and the wheel are separate components secured to one another.

11. The knob of claim 6 wherein the frictional surface is selected from the group consisting of sandpaper, rubber and adhesive.

12. The knob of claim 6 further comprising a visual indicator on the wheel to indicate degree of rotation of the rotatable control.

13. The knob of claim 6 wherein the shaft is cylindrical and has a first diameter and wherein the wheel is circular and has a second diameter at least three times greater than the first diameter, wherein the wheel comprises a transparent portion.

14. A foot operated musical instrument effects pedal comprising first and second adjacent knobs for adjusting rotatable controls, the first knob comprising:
a. a shaft having a first end, a second end, and an outer perimeter bounding a first cross-sectional area, the first end being securable to a first rotatable control;
b. a wheel located at the second end of the shaft, the wheel having an outer perimeter bounding a second cross-sectional area which is greater than the first cross-sectional area and a bottom surface rigidly attached to the second end of the shaft;
c. wherein the wheel extends over at least a portion of the second knob, such that the first knob does not interfere with rotation of the second knob and the second knob does not interfere with rotation of the first knob.

15. The pedal of claim 14 wherein the shaft of the first knob has a first height and the second knob has a second height that is less than the first height.

16. The pedal of claim 14 wherein the wheel further comprises a top surface located opposite the bottom surface, wherein at least a portion of the top surface has a frictional surface adapted to receive a user's foot for rotating the knob and thereby adjusting the rotatable control.
